(19) United States
(12) Patent Application Publication
(10) Pub. No.: US 2009/0267919 A1
(43) Pub. Date: Oct. 29, 2009

(54) MULTI-TOUCH POSITION TRACKING APPARATUS AND INTERACTIVE SYSTEM AND IMAGE PROCESSING METHOD USING THE SAME

(75) Inventors: SHIH-PIN CHAO, Taipei County (TW); CHIA-CHEN CHEN, Hsinchu City (TW); CHING-LUNG HUANG, Hsinchu City (TW); TUNG-FA LIOU, Hsinchu City (TW); PO-HUNG WANG, Kaohsiung County (TW); CHENG-YUAN TANG, Taipei County (TW)

Correspondence Address: WPAT, PC, 7225 BEVERLY ST., ANNANDALE, VA, 22003, US

(73) Assignee: INDUSTRIAL TECHNOLOGY RESEARCH INSTITUTE, Hsin-Chu (TW)

(21) Appl. No.: 12/141,248

(22) Filed: Jun. 18, 2008

(30) Foreign Application Priority Data
Apr. 25, 2008 (TW) 097115180

(51) Int. Cl. G06F 3/042

(52) U.S. Cl. 345/175

(57) ABSTRACT

The present invention provides a multi-touch position tracking technique and an interactive system and a multi-touch interactive image processing method using the same. In the present invention, a light guide element is designed to comprise frustrating structures to frustrate total internal reflection (TIR) so that the light beam therein can be dispersed to form a dispersed optical field distribution. The dispersed optical field is used to respond a physical relation between an object and the light guide element.

### BACKGROUND OF THE INVENTION

1. Field of the Invention

The present invention generally relates to a multi-touch position tracking technique and, more particularly, to a multi-touch position tracking apparatus, an interactive system and an image processing method.

2. Description of the Prior Art

In a multi-touch system, the user is able to interact with the multi-media interactive system using multiple objects (such as fingers) to touch the interface. Conventionally, the single-touch scheme is used in the touch system so that the touch system is restrictedly used. However, since the consumer digital products have been developed towards compactness and the interactions between the user and the products have changed, the multi-touch approach has attracted tremendous attention to replace conventional single-touch technique.

In FIG. 1, which is a cross-sectional view of a conventional multi-touch display device disclosed in U.S. Pat. Appl. No. 20080029691, the multi-touch display device comprises a light guide plate 10 with a light source 11 on one side to receive an incoming light beam from the light source 11 into the light guide plate 10. Since the refractive index of the air outside the light guide plate 10 is smaller than that of the light guide plate 10. With a pre-designed incoming angle, the light beam entering the light guide plate 10 is confined inside the light guide plate 10 due to total internal reflection (TIR). However, as the user uses an object (such as the skin on a finger) with a higher refractive index to touch the surface of the light guide plate 10, total internal reflection is frustrated at the point where the object touches the light guide plate 10 so that a dispersed optical field 13 is formed due to light leaking into the air. The dispersed optical field 13 is then received by a sensor module 14 to be further processed.

Moreover, U.S. Pat. No. 3,200,701 discloses a technique to image fingerprint ridges by frustrated total internal reflection. In U.S. Pat. No. 3,200,701, the light from a light source is introduced into a light guide element (such as glass) with a refractive index higher than the air so that total internal reflection takes place in the light guide element. When the skin of a finger touches the light guide element, total internal reflection will be frustrated because the refractive index of the skin is higher than that of the light guide element. A sensed image with patterns formed by the dispersed light beam dispersed by the skin is then sensed by the sensor module to identify the fingerprint on the skin of the finger.

Furthermore, U.S. Pat. No. 6,061,177 discloses a touch-sensing apparatus incorporating a touch screen panel adapted for use with a rear-projected computer display using total internal reflection. In U.S. Pat. No. 6,061,177, a sensor module is disposed on one side of the touch screen panel. A polarizer is disposed between the sensor module and the touch screen panel to filter out the non-TIR light so that the sensor module will not receive dispersed light due to frustrated total internal reflection by the skin of the finger (or other material with a higher refractive index than the touch screen panel). Accordingly, a dark zone is formed on a position where the skin of the finger the touch screen panel to be used as a basis for interactive touch-sensing.

### SUMMARY OF THE INVENTION

The invention provides a multi-touch position tracking apparatus, using a light guide element designed to comprise frustrating structures to frustrate total internal reflection (TIR) so that the light beam therein can be dispersed to form a dispersed optical field distribution over the light guide element. The dispersed optical field is used to respond a physical relation between a contact/non-contact object and the light guide element.

The invention provides a multi-touch interactive system, using a light guide element designed to comprise frustrating structures to frustrate total internal reflection (TIR) so that the light beam therein can be dispersed to form a dispersed optical field distribution over the light guide element. The dispersed optical field is used to respond a physical relation between a contact/non-contact object and the light guide element. An interactive program is controlled according to the physical relation to interact with the user.

The invention provides a multi-touch interactive image processing method for processing a sensed image detected from the dispersed optical field, and determining the physical relation between the object and the light guide element.

The present invention provides a multi-touch position tracking apparatus, comprising: a light source; a light guide element capable of receiving an incoming optical field from the light source and enabling the incoming optical field to go out from a side surface of the light guide element to form a dispersed optical field; a sensor module capable of sensing the light from the dispersed optical field being dispersed or reflected to acquire a sensed image; and a processing unit capable of determining a physical relation between at least an object and the light guide element corresponding to the sensed image.

The present invention provides a multi-touch interactive system, comprising: a light source; a light guide element capable of receiving an incoming optical field from the light source and enabling the incoming optical field to go out from a side surface of the light guide element to form a dispersed optical field; a sensor module capable of sensing the light from the dispersed optical field being dispersed or reflected to acquire a sensed image; a processing unit capable of determining a physical relation between at least an object and the light guide element corresponding to the sensed image and generating a control signal corresponding to the physical relation or the variation of the physical relation; and a display device capable of generating an interactive image according to the control signal.

The present invention provides a multi-touch interactive image processing method, comprising steps of: (a) providing a light guide element and a sensor module, the light guide element capable of receiving an incoming optical field and enabling the incoming optical field to go out therefrom to form a dispersed optical field being incident on at least an object so that a dispersed/reflected light beam from the object is received by the sensor module to form a sensed image; (b) filtering the sensed image according to at least a threshold value to form at least a filtered image; (c) analyzing the filtered image to acquire at least a group of characteristic values corresponding to the filtered image and the object; (d) determining a physical relation between the object and the light guide element according to the characteristic values; and (e) tracking the variation of the physical relation.

### BRIEF DESCRIPTION OF THE DRAWINGS

The objects, spirits and advantages of the preferred embodiments of the present invention will be readily understood by the accompanying drawings and detailed descriptions, wherein:

FIG. 1 is a cross-sectional view of a conventional multi-touch display device;

FIG. 2A is a schematic diagram of a multi-touch position tracking apparatus according to a first embodiment of the present invention;

FIG. 2B is a schematic diagram of a multi-touch position tracking apparatus according to another embodiment of the present invention;

FIG. 3A and FIG. 3B are cross-sectional views showing the operation of a multi-touch position tracking apparatus according to a first embodiment of the present invention;

FIG. 4 is a flowchart of a multi-touch interactive image processing method according to a first embodiment of the present invention;

FIG. 5 is a flowchart of a multi-touch interactive image processing method according to a second embodiment of the present invention;

FIG. 6 is a schematic diagram of a multi-touch position tracking apparatus according to a second embodiment of the present invention;

FIG. 7A and FIG. 7B are cross-sectional views showing the operation of a multi-touch position tracking apparatus according to a second embodiment of the present invention;

FIG. 8A is a schematic diagram of a multi-touch interactive system according to a first embodiment of the present invention;

FIG. 8B is a schematic diagram of a multi-touch interactive system according to a second embodiment of the present invention;

FIG. 9 is a flowchart of a multi-touch interactive image processing method according to a third embodiment of the present invention; and

FIG. 10 is a schematic diagram of a multi-touch interactive system according to a third embodiment of the present invention.

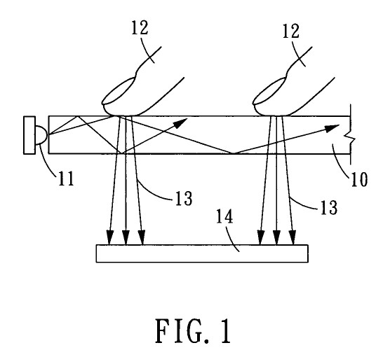

### DETAILED DESCRIPTION OF THE PREFERRED EMBODIMENT

The present invention can be exemplified but not limited by the embodiment as described hereinafter.

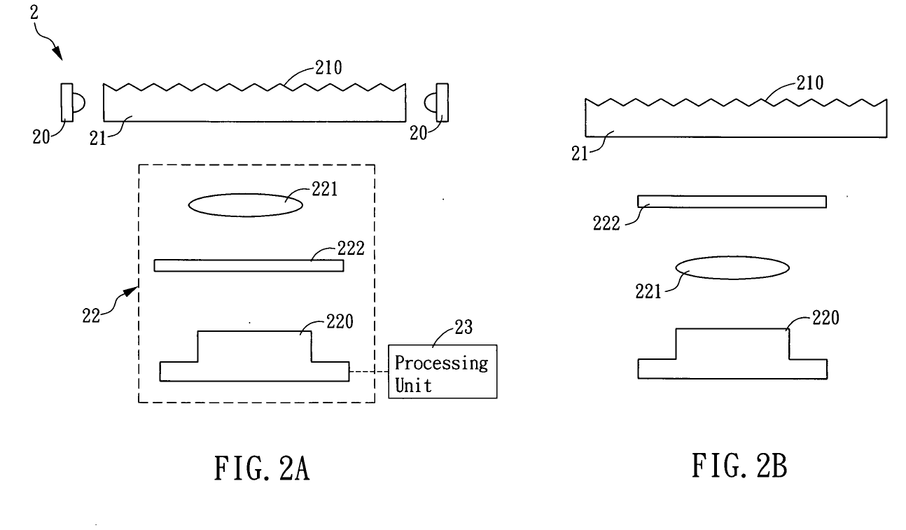

Please refer to FIG. 2A, which is a schematic diagram of a multi-touch position tracking apparatus according to a first embodiment of the present invention. The multi-touch position tracking apparatus 2 comprises at least a light source 20, a light guide element 21, a sensor module 22 and a processing unit 23. The light source 20 can be an infrared light source, but is not restricted thereto. For example, the light source 20 can also be an ultra-violet light source. Generally, the light source 20 is implemented using a light emitting diode (LED), a laser or other non-visible light source. In the present embodiment, the light source 20 is an infrared light emitting diode (LED). The light guide element 21 is capable of receiving an incoming optical field from the light source 20. The light guide element 21 comprises a dispersing structure 210 on a surface to frustrate total internal reflection (TIR) so that the incoming optical field is dispersed to form a dispersed optical field with a distribution having a specific height. The specific height is not restricted and is dependent on the intensity of the light source 20.

The sensor module 22 is capable of sensing the light from the dispersed optical field being dispersed or reflected to acquire a sensed image. The sensor module 22 further comprises an image sensor 220 and a lens set 221. In the present embodiment, the image sensor 220 is an infrared CCD image sensor.

The lens set 221 is disposed between the image sensor 220 and the light guide element 21 to form the sensed image on the image sensor. In order to prevent the image acquired by the image sensor 220 from being interfered by other light source, an optical filter 222 is further disposed between the lens set 221 and the image sensor 220. In the present embodiment, the optical filter 222 is an infrared band-pass optical filter to filter out non-infrared light (such as background visible light) to improve sensing efficiency of the image sensor 220. The number of image sensors 220 is determined according to practical use and is thus not restricted as shown in FIG. 2A.

As shown in FIG. 2B, which is a schematic diagram of a multi-touch position tracking apparatus according to another embodiment of the present invention. In the present embodiment, the optical filter 222 is disposed between the light guide element 21 and the lens set 221.

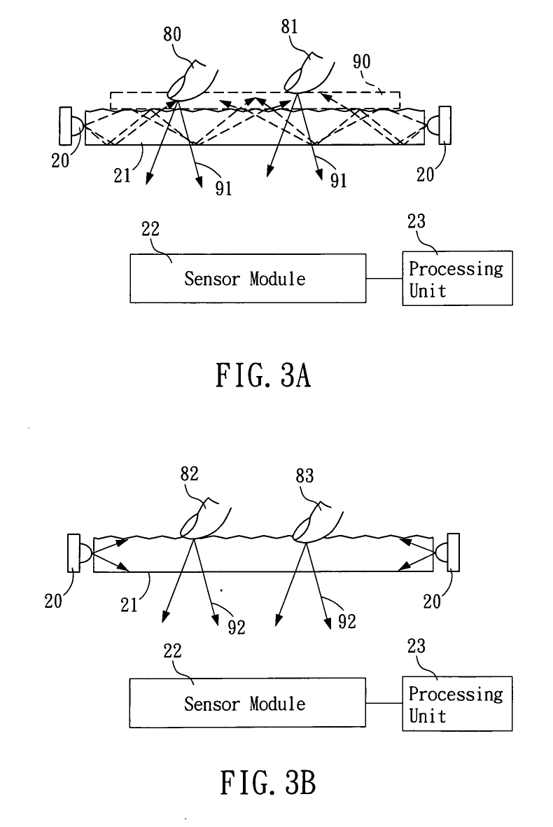

Please refer to FIG. 3A and FIG. 3B for are cross-sectional views showing the operation of a multi-touch position tracking apparatus according to a first embodiment of the present invention. In FIG. 3A, since the dispersed optical field 90 is formed with a specific height from the surface of the light guide element 21, the light from the dispersed optical field 90 is dispersed or reflected by the surfaces of the objects 80 and 81 to issue a sensing optical field 91 when the objects 80 and 81 (such as fingers or other pointing devices) are coming closer. The sensing optical field 91 passes through the light guide element 21 and is received by the sensor module 22 so as to be processed to form a sensed image. Moreover, as shown in FIG. 3B, the objects 82 and 83 contact the surface of the light guide element 21. Similarly, the light from the dispersed optical field is dispersed by the objects 82 and 83 contacting the surface of the light guide element 21 to form a sensing optical field 92. The sensing optical field 92 is received by the sensor module 22 to be processed to form a sensed image.

Returning to FIG. 2A, the processing unit 23 is coupled to the sensor module 22 to receive the sensed image, determines a physical relation between at least an object and the light guide element 21 corresponding to the sensed image according to the sensed image and tracks the variation of the physical relation. The physical relation represents the three-dimensional position of the non-contact objects 80 and 81 as shown in FIG. 3A or the two-dimensional position of the objects 82 and 83 contacting the light guide element 21 as well as the pressure applied to the light guide element 21 as shown in FIG. 3B.

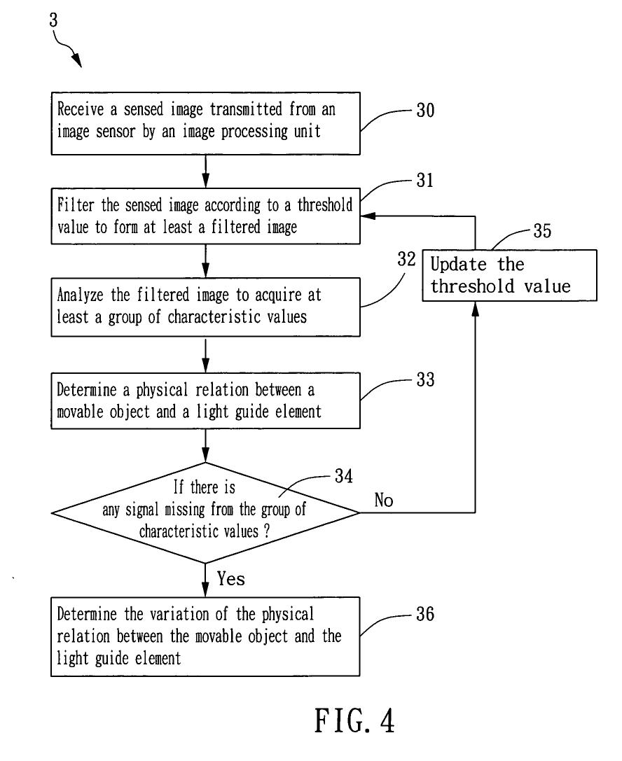

The process for the processing unit 23 to process the sensed image to analyze the physical relation between the object and the light guide element is described hereinafter. Please refer to FIG. 2A and FIG. 4, wherein FIG. 4 is a flowchart of a multi-touch interactive image processing method according to a first embodiment of the present invention. In the present embodiment, the method 3 comprises steps as follows. First in Step 30, the processing unit 23 receives a sensed image transmitted from the image sensor 20. Then, Step 31 is performed to filter the sensed image according to a threshold value to form at least a filtered image. The threshold value is a luminance threshold value. The object of the present step is to determine at least a luminance threshold value and to compare the luminance value of each pixel in the sensed image to the threshold value. The luminance value is kept if it is larger than the threshold value. Therefore, the filtered image with a luminance value larger than or equal to the threshold value is acquired after the luminance value is compared to the threshold value.

Step 32 is then performed to analyze the filtered image to acquire at least a group of characteristic values corresponding to each filtered image. The characteristic values represent the luminance in an image pixel. The undesired noise has been filtered out in Step 31. However, it is likely that a plurality of objects (such as a plurality of fingers of a hand or two hands) touch the light guide element 21 at the same time in a contact/non-contact fashion to determine the position or the pressure. Different objects result in different luminance values. Therefore, the luminance values larger than the threshold value have to be classified to identify the positions of the objects or the contact pressure applied to the light guide element. According to Step 32, the number of classified group of characteristic values is capable of determining the number of objects touching the light guide element 21.

Then, Step 33 is performed to determine a physical relation between each object and the light guide element 21 according to the group of characteristic values. Since the luminance ranges corresponding to each group of characteristic values and the positions sensed by the image sensor 220 are not the same, therefore the object of the present step is to obtain the physical relation between the object corresponding to the group of characteristic values and the light guide element 21 according to the luminance range and the position information sensed by the image sensor 220. The physical relation comprises the position between the object and the light guide element and the contact pressure applied to the light guide element 21.

After Step 33, Step 34 is performed to determine if there is any signal missing from the group of characteristic values. The object of the present step is to determine whether there is any signal missing from the group of characteristic values due to the variation of the pressure on the light guide element 21 resulting from the sliding of the object contacting the light guide element 21. Therefore, Step 35 is performed if there is any signal missing to update the threshold value. Step 31 is re-performed to form an updated filtered image according to the updated threshold value. After returning to Step 34, Step 36 is performed to determine the variation between the present physical relation and the previous physical relation if there is no signal missing. By repeating from Step 30 to Step 36, it is possible to keep tracking the position of each (contact/non-contact) object on the light guide element 21 or the pressure and variation thereof.

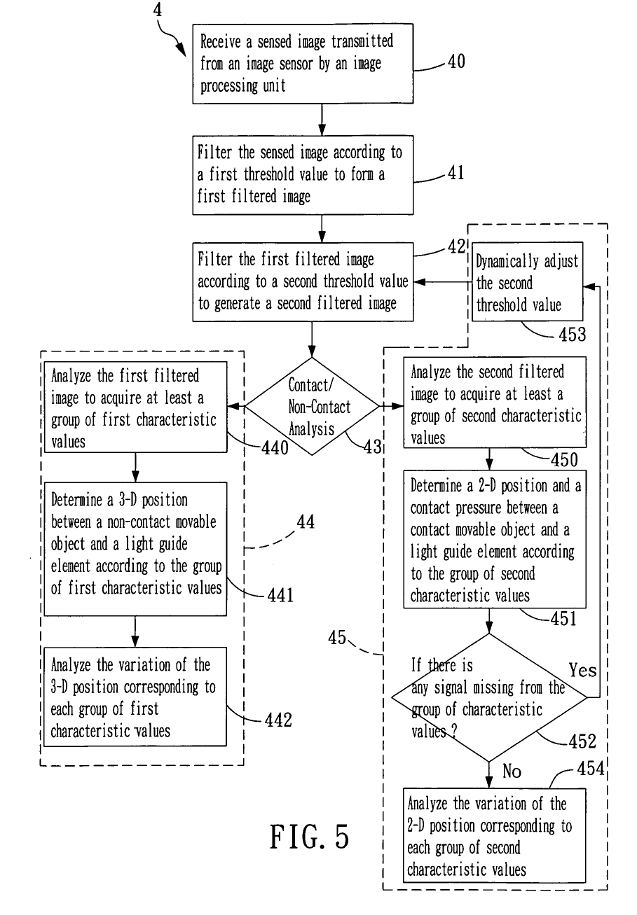

Please refer to FIG. 5, which is a flowchart of a multi-touch interactive image processing method according to a second embodiment of the present invention. In the present embodiment, the operation of the processing unit 23 when there are both contact and non-contact objects is described hereinafter. In the present embodiment, the method 4 comprises steps as follows. First in Step 40, the processing unit 23 receives a sensed image transmitted from the image sensor 20. Then, Step 41 is performed to filter the sensed image according to a first threshold value to form at least a first filtered image. Step 42 is then performed to filter the first filtered image according to a second threshold value to form at least a second filtered image. In Step 41 and Step 42, the first threshold value and the second threshold value represent luminance threshold values and the first threshold value is smaller than the second threshold value. The first and the second threshold values are different to distinguish the images formed due to the contact object and the non-contact object, respectively. Since the image due to the contact object is formed directly on the light guide element, the luminance of the light dispersed by the contact object is higher than that by the non-contact object. In Step 41 and Step 42, the first filtered image corresponding to the non-contact object and the second filtered image corresponding to the contact object can be acquired according to the difference between the first threshold value and the second threshold value.

Step 43 is then performed to analyze the first filtered image and the second filtered image. In Step 43, the first filtered image corresponding to the non-contact object and the second filtered image corresponding to the contact object are distinguished so that the first filtered image and the second filtered image are then analyzed in Step 44 and Step 45, respectively.

In Step 44, Step 440 is first performed to analyze the first filtered image to acquire at least a group of first characteristic values corresponding to the first filtered image and the geometric position of the group of first characteristic values. Each group of first characteristic values corresponds to an object, while the characteristic values correspond to the luminance of an image pixel. For example, in FIG. 3A, two groups of characteristic values correspond to two non-contact objects 80 and 81. In Step 440, since the heights between different objects and the light guide element are different, the luminance values of the corresponding dispersed optical fields are different. Therefore, in order to distinguish three-dimensional positions of the plurality of non-contact objects, the luminance values larger than the threshold value have to be classified. Then, Step 441 is performed to determine a 3-D position between a non-contact object and a light guide element according to the group of first characteristic values. Since the distances between different objects and the light guide element are different, the luminance values corresponding to the groups of characteristic values are not the same. Therefore, in the present step, the positions between the light guide element and the objects corresponding to each group of characteristic values can be determined according to the luminance information. On the other hand, the positions of the group of characteristic values corresponding to the first filtered image represent the positions sensed by the image sensor, which can be interpreted as positions corresponding to the light guide element. Therefore, two-dimensional positions of the objects on the light guide element can be acquired according to geometric positions corresponding to each group of characteristic values. Furthermore, three-dimensional positions of the objects relative to the light guide element can be determined according to the two-dimensional positions and the heights. Then, Step 442 is performed to analyze the variation of the 3-D positions corresponding to each group of first characteristic values according to the next detection and analysis.

Moreover, the second filtered image is analyzed in Step 45. In Step 45, Step 450 is first performed to analyze the second filtered image to acquire at least a group of second characteristic values corresponding to the second filtered image. Each group of second characteristic values corresponds to an object, while the characteristic values correspond to the luminance of an image pixel. In order to distinguish the two-dimensional positions and contact pressures of the plurality of objects, the luminance values larger than the threshold value have to be classified. In Step 450, even though all the objects contact the light guide element, the contact pressures for each object on the light guide element are not necessarily identical. For example, in FIG. 3B, two contact objects 82 and 83 contact the light guide element and the contact pressure of the object 83 on the light guide element is larger than the contact pressure of the object 82 on the light guide element. Therefore, the luminance values of the dispersed optical fields corresponding to the objects 82 and 83 are different. Accordingly, the groups of characteristic values corresponding to the contact objects 82 and 83 can be respectively acquired.

Returning to FIG. 5, after Step 450, Step 451 is performed to determine a 2-D position and a contact pressure between a contact object and a light guide element according to the group of second characteristic values. Since the contact pressures of different objects on the light guide element are different, the luminance values corresponding to the groups of characteristic values are not the same. Therefore, in the present step, the contact pressures of different objects on the light guide element corresponding to each group of characteristic values can be determined according to the luminance information. On the other hand, the positions of the group of characteristic values corresponding to the second filtered image represent the positions sensed by the image sensor, which can be interpreted as positions corresponding to the light guide element. Therefore, two-dimensional positions of the objects contacting the light guide element can be acquired according to geometric positions corresponding to each group of characteristic values.

After Step 451, Step 452 is performed to determine if there is any signal missing from the group of characteristic values. The object of the present step is to determine whether there is any signal missing from the group of characteristic values due to the variation of the pressure on the light guide element 21 resulting from the sliding of the object contacting the light guide element 21. Therefore, Step 453 is performed if there is any signal missing to update the second threshold value. Step 42 is re-performed to form an updated second filtered image according to the updated second threshold value. After returning to Step 452, Step 454 is performed to determine the variations between the present two-dimensional position and pressure and the previous two-dimensional position and pressure to acquire the variations of the 2-D positions and pressures of the objects on the light guide element if there is no signal missing. By repeating from Step 40 to Step 45, it is possible to keep tracking each (contact/non-contact) object on the light guide element 21.

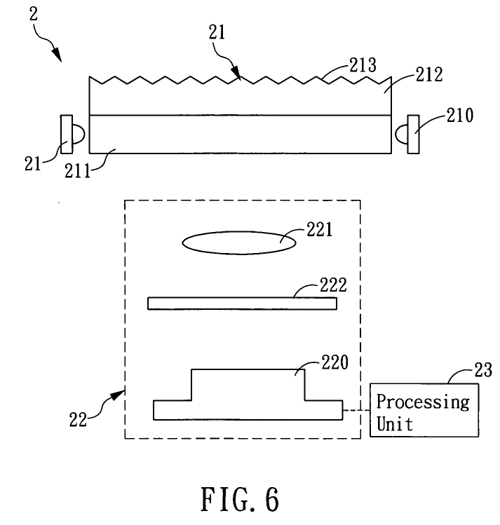

Please refer to FIG. 6, which is a schematic diagram of a multi-touch position tracking apparatus according to a second embodiment of the present invention. In the present embodiment, the light guide element 21 comprises a light guide plate 211 and a light guide sheet 212. The light guide plate 211 is capable of receiving an incoming optical field. The light guide sheet 212 is connected one side surface of the light guide plate 211. The refractive index of the light guide sheet 212 is larger than that of the light guide plate 211. The light guide sheet 212 comprises a dispersing structure 213 on the surface to enable the incoming optical field to go out to form a dispersed optical field.

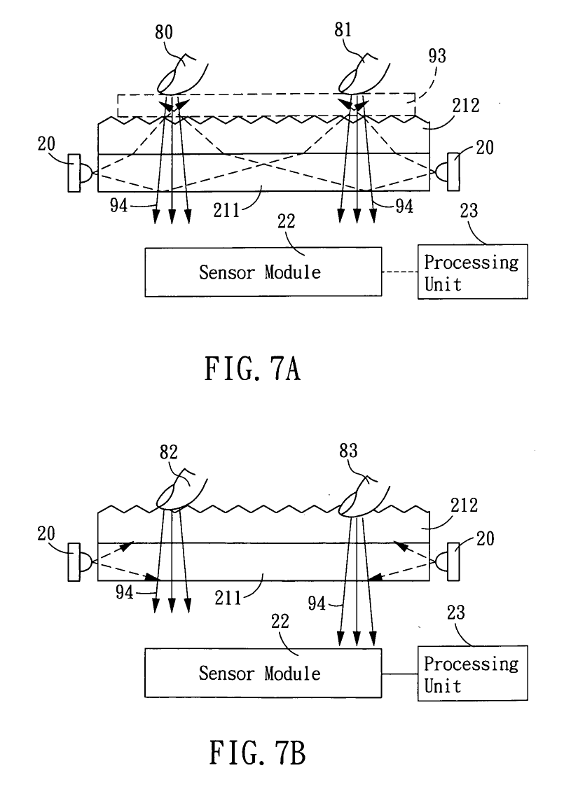

Please refer to FIG. 7A and FIG. 7B for are cross-sectional views showing the operation of a multi-touch position tracking apparatus according to a second embodiment of the present invention. In FIG. 7A, since the dispersed optical field 93 is formed with a specific height from the surface of the light guide sheet 212, the light from the dispersed optical field 93 is dispersed or reflected by the surfaces of the objects 80 and 81 to issue a sensing optical field 94 when the objects 80 and 81 (such as fingers or other pointing devices) are coming closer. The sensing optical field 94 passes through the light guide sheet 212 and the light guide plate 211 and is received by the sensor module 22 so as to be processed to form a sensed image. Moreover, as shown in FIG. 7B, the objects 82 and 83 contact the surface of the light guide element 21. Similarly, the light from the dispersed optical field is dispersed by the objects 82 and 83 contacting the surface of the light guide sheet 212 to form a sensing optical field 94. The sensing optical field 94 is received by the sensor module 22 to be processed to form a sensed image.

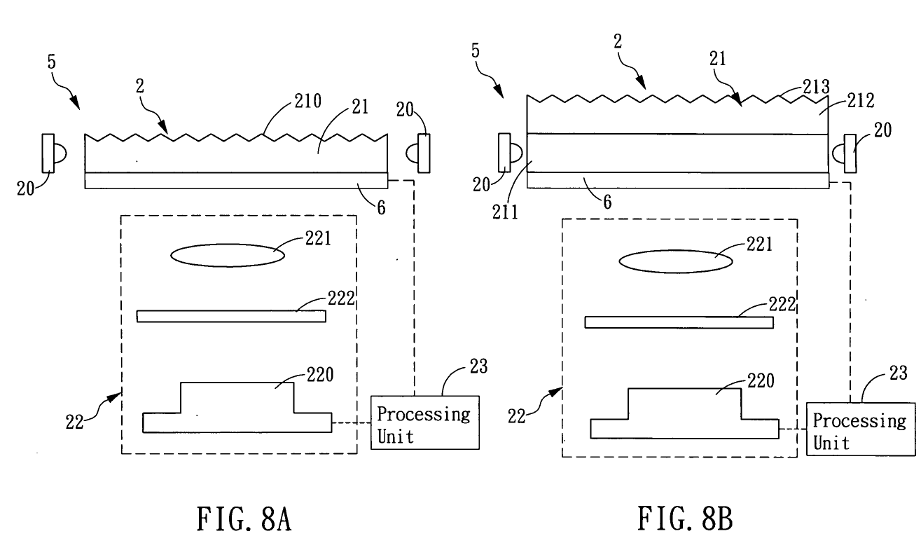

Please refer to FIG. 8A, which is a schematic diagram of a multi-touch interactive system according to a first embodiment of the present invention. In the present embodiment, the multi-touch interactive system 5 uses the multi-touch position tracking apparatus 2 in FIG. 2A and a display device 6. The light source 20, the light guide element 21 and the sensor module 22 are similar to those as described and thus descriptions thereof are not repeated. The processing unit 23 is capable of determining a physical relation between at least an object corresponding to the sensed image and the light guide element 21 according to the sensed image and is capable of tracking the variation of the physical relation to issue a control signal corresponding to the physical relation or the variation of the physical. The display device 6 is disposed between the sensor module 22 and the light guide element 21. The display device 6 is capable of generating an interactive image according to the control signal. In the present embodiment, the display device 6 is coupled to the light guide element 21 so that the user is able to watch and interact with the image displayed on the display device 6 through the light guide element 21. Moreover, the display device 6 is a distance away from the light guide element 21. The distance is not restricted as long as the user is able to watch the image displayed on the display device 6. Generally, the display device 6 can be a rear-projection display device or a liquid-crystal display device.

Please refer to FIG. 8B, which is a schematic diagram of a multi-touch interactive system according to a second embodiment of the present invention. In the present embodiment, the multi-touch position tracking apparatus 2 in FIG. 6 is combined with the display device 6. In other words, the light guide element 21 comprises a light guide plate 211 and a light guide sheet 212. The other elements in FIG. 8B are similar to those as described in FIG. 8A, and thus descriptions thereof are not repeated.

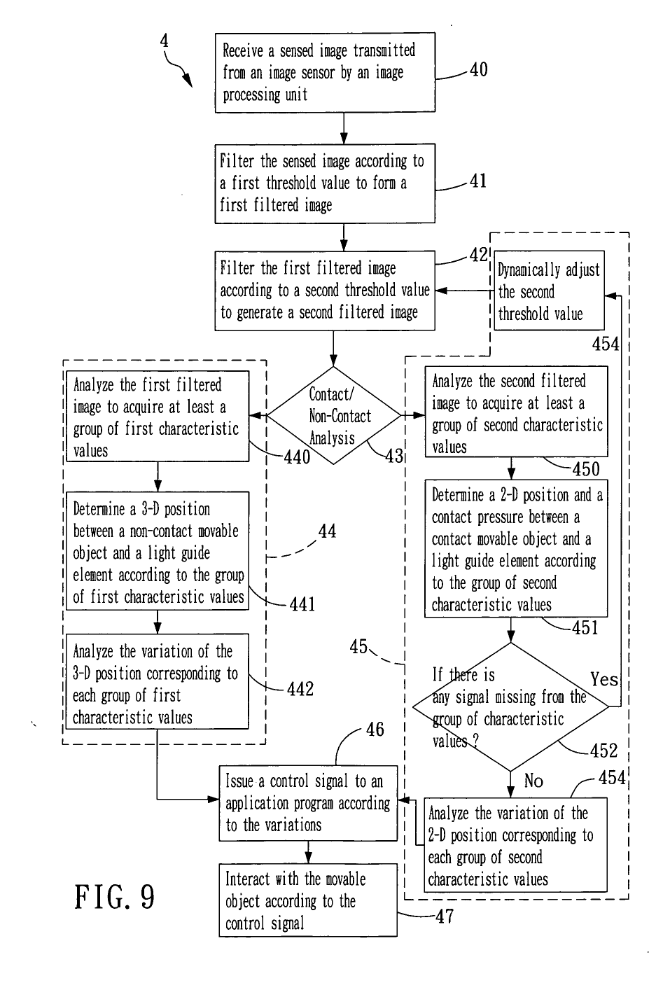

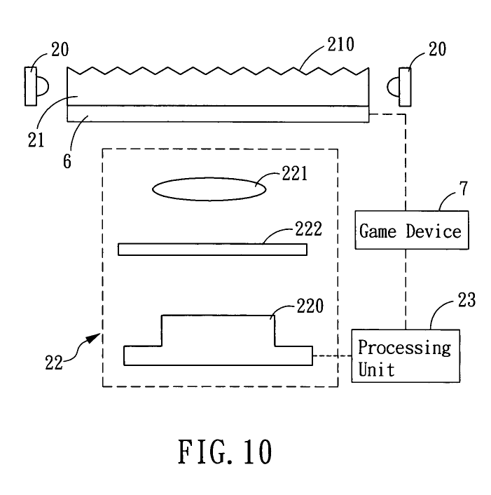

Please refer to FIG. 9, which is a flowchart of a multi-touch interactive image processing method according to a third embodiment of the present invention. In the present invention, the image processing method is similar to the method in FIG. 5 to identify the contact/non-contact objects except that the method in FIG. 9 further comprises Step 46 to issue a control signal to an application program according to the variations of the physical relations. The application program can be a game or application software in the display device. Alternatively, as shown in FIG. 10, the application program can also be executed in a game device 7 coupled to the display device 6. Returning to FIG. 9, Step 47 is performed, in which the application program is capable of interacting with the object according to the control signal.

According to the above discussion, it is apparent that the present invention discloses a multi-touch position tracking apparatus, an interactive system and an image processing method using frustrated total internal reflection (FTIR) to detect information of an object. Therefore, the present invention is novel, useful and non-obvious.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A multi-touch position tracking apparatus, comprising:
a light source;
a light guide element capable of receiving an incoming optical field from the light source and enabling the incoming optical field to go out from a side surface of the light guide element to form a dispersed optical field;
a sensor module capable of sensing the light from the dispersed optical field being dispersed or reflected to acquire a sensed image; and
a processing unit capable of determining a physical relation between at least an object and the light guide element corresponding to the sensed image.

2. The multi-touch position tracking apparatus as recited in claim 1, wherein the light guide element comprises a dispersing structure on the side surface.

3. The multi-touch position tracking apparatus as recited in claim 1, wherein the light guide element further comprises:
a light guide plate capable of receiving the incoming optical field; and
a light guide sheet connected to one side surface of the light guide plate;
wherein the refractive index of the light guide sheet is larger than the refractive index of the light guide plate, and the light guide sheet comprises a dispersing structure to enable the incoming optical field to go out to form the dispersed optical field.

4. The multi-touch position tracking apparatus as recited in claim 2, wherein the light source is an infrared light emitting diode (LED), an infrared laser or a non-visible light source.

5. The multi-touch position tracking apparatus as recited in claim 1, wherein the sensor module further comprises:
an image sensor; and
a lens set capable of forming the sensed image on the image sensor.

6. The multi-touch position tracking apparatus as recited in claim 5, further comprising an optical filter disposed between the lens set and the image sensor or between the lens set and the light guide element.

7. The multi-touch position tracking apparatus as recited in claim 1, wherein the physical relation is a position or a pressure applied on the light guide element.

8. A multi-touch interactive system, comprising:
a light source;
a light guide element capable of receiving an incoming optical field from the light source and enabling the incoming optical field to go out from a side surface of the light guide element to form a dispersed optical field;
a sensor module capable of sensing the light from the dispersed optical field being dispersed or reflected to acquire a sensed image;
a processing unit capable of determining a physical relation between at least an object and the light guide element corresponding to the sensed image and generating a control signal corresponding to the physical relation or the variation of the physical relation; and
a display device capable of generating an interactive image according to the control signal.

9. The multi-touch interactive system as recited in claim 8, wherein the light guide element is a light guide plate comprising a dispersing structure on the side surface wherefrom the incoming optical field goes out.

10. The multi-touch interactive system as recited in claim 8, wherein the light guide element further comprises:
a light guide plate capable of receiving the incoming optical field; and
a light guide sheet connected to one side surface of the light guide plate;
wherein the light guide sheet comprises a dispersing structure to enable the incoming optical field to go out to form the dispersed optical field.

11. The multi-touch interactive system as recited in claim 8, wherein the light source is an infrared light emitting diode (LED), an infrared laser or a non-visible light source.

12. The multi-touch interactive system as recited in claim 8, wherein the sensor module further comprises:
an image sensor; and
a lens set capable of forming the sensed image on the image sensor.

13. The multi-touch interactive system as recited in claim 12, further comprising an optical filter disposed between the lens set and the image sensor or between the lens set and the light guide element.

14. The multi-touch interactive system as recited in claim 8, wherein the display device and the light guide element are coupled.

15. The multi-touch interactive system as recited in claim 8, wherein the display device is a rear-projection display device or a liquid-crystal display device.

16. The multi-touch interactive system as recited in claim 8, wherein the physical relation is a position or a pressure applied on the light guide element.

17. A multi-touch interactive image processing method, comprising steps of:
(a) providing a light guide element and a sensor module, the light guide element capable of receiving an incoming optical field and enabling the incoming optical field to go out therefrom to form a dispersed optical field being incident on at least an object so that a dispersed/reflected light beam from the object is received by the sensor module to form a sensed image;
(b) filtering the sensed image according to at least a threshold value to form at least a filtered image;
(c) analyzing the filtered image to acquire at least a group of characteristic values corresponding to the filtered image and the object;
(d) determining a physical relation between the object and the light guide element according to the characteristic values; and
(e) tracking the variation of the physical relation.

18. The multi-touch interactive image processing method as recited in claim 17, wherein the physical relation is a position or a pressure applied on the light guide element.

19. The multi-touch interactive image processing method as recited in claim 17, wherein the characteristic values represent luminance.

20. The multi-touch interactive image processing method as recited in claim 17, wherein step (b) further comprises steps of:
(b1) determining a first threshold value and a second threshold value;
(b2) filtering the sensed image according to the first threshold value to form a first filtered image; and
(b3) filtering the first filtered image according to the second threshold value to form a second filtered image.

21. The multi-touch interactive image processing method as recited in claim 20, wherein the first filtered image corresponds to at least a non-contact object and the second filtered image corresponds to at least a contact object.

22. The multi-touch interactive image processing method as recited in claim 17, further comprising between step (d) and step (e) steps of:
(d1) determining if there is any signal missing from the group of characteristic values and determining the variation between a previous physical relation and a next physical relation if there is no signal missing; and
(d2) updating the threshold value if there is the variation so as to form an updated filtered image and repeating from step (a) to step (d).

23. The multi-touch interactive image processing method as recited in claim 17, further comprising steps of:
(f) issuing a control signal to an application program according to the variation of the physical relation; and
(d2) interacting with the object according to the control signal.
